(19) United States
(12) Patent Application Publication
(10) Pub. No.: US 2025/0155328 A1
(43) Pub. Date: May 15, 2025

(54) CORING SAMPLER DEVICE AND METHOD OF RETRIEVING A SOIL SAMPLE

(71) Applicant: FNV IP B.V., Leidschendam (NL)

(72) Inventor: Chad Allen PASTOR, Lafayette, LA (US)

(21) Appl. No.: 18/505,607

(22) Filed: Nov. 9, 2023

(51) Int. Cl. G01N 1/08

(52) U.S. Cl. CPC G01N 1/08

(57) ABSTRACT

The present disclosure generally relates to a coring sampler for retrieving coring samples, the coring sampler comprising an elongated coring section and a cutting shoe. The present disclosure also relates to a method of retrieving a soil sample and to a cutting shoe for use in a coring sampler. Unlocking insights from Geo-Data, the present invention further relates to improvements in sustainability and environmental developments: together we create a safe and liveable world.

### FIELD OF THE INVENTION

The present disclosure generally relates to a coring sampler for retrieving coring samples, the coring sampler comprising an elongated coring section and a cutting shoe. The present disclosure also relates to a method of retrieving a soil sample and to a cutting shoe for use in a coring sampler. Unlocking insights from Geo-Data, the present invention further relates to improvements in sustainability and environmental developments: together we create a safe and liveable world.

### BACKGROUND OF THE INVENTION

There is a general and ongoing need to improve information of the soil through determining subsurface characteristics of the soil. Such subsurface characteristics may be soil type, density, moisture content, shear modulus, and the like, which may be used in foundation planning and/or management. Such soil characteristics may play a vital role in e.g., infrastructure projects, but may also be used to map soil characteristics for different purposes such as environmental projects, coastal resilience projects, or dam integrity projects. As an example, to determine what types of foundations are required for a e.g., an offshore wind farm, the soil types and their characteristics must be investigated.

One of the methods of determining subsurface characteristic is by retrieving soil samples from a target soil such that they can be analysed. An example of sample retrieval is coring, in which a tubular coring sampler is driven into the soil and receives the target soil in a hollow section within an elongated section of the sampler. The coring sampler is then retrieved from the soil and the soil sample contained in the hollow section of the sampler is retrieved for analysis. In particular in marine surveying, it is often required to collect sub seabed samples by means of coring ranging from a few meters to thirty meters below the seafloor.

A core sample is typically a cylindrical section of a naturally occurring substance. Core samples can be obtained by drill coring, in which the sample is obtained by drilling with special drills into the substance, such as sediment or rock, with a hollow steel tube, called a core drill. The hole made for the core sample is called the “core hole”. However, drill coring is very expensive and can hamper the efficiency of obtaining information on soil characteristics due to its expensive and cumbersome approach.

Contrary to drill coring, the present disclosure relates to coring in which a cutting shoe is pressed linearly into the soil, without rotary motion required for e.g., a drill. The cutting shoe is pressed into the soil to take a soil sample.

Gravity coring is a method in which the core sampler is dropped into the sample, usually the bed of a water body, but essentially the same technique can also be done on soft materials on land. Piston coring is a method in which is a long, heavy tube plunged into the seafloor to extract samples of mud sediment. While a gravity corer is just a weighted pipe that is allowed to free fall into the water, piston corers have a piston mechanism that is triggered when the corer hits the bottom. The piston helps to avoid disturbing the sediment. Piston corers and gravity are generally used in areas with soft sediment, such as clay or sandy clay.

However, even in softer sediments, gravity and piston coring methods often cannot reach the required depth. This is mainly due to the friction experienced by the corers, exerted by the target soil to the corer, in relation to their mass and velocity. If information is needed about a target soil at a given depth, but traditional gravity and/or piston coring samplers cannot reach that depth, a drill coring sampler needs to be used, which makes the process of obtaining information on the soil characteristics much more expensive and time consuming.

There is thus a need for a coring sampler which addresses the above problems and provides increased depth without reverting to more complex, expensive, or time consuming approaches.

### BRIEF SUMMARY OF THE INVENTION

In one aspect of the present disclosure there is provided a coring sampler for retrieving coring samples. The coring sampler comprises an elongated coring section. In an implementation, the elongated coring section defines at least a hollow space extending between a proximal end and a distal end. The coring sampler comprises a cutting shoe. The cutting shoe comprises a connection side and an engagement side. In an implementation, the connection side is attached to the distal end of the elongated coring section.

The engagement side of the cutting shoe comprises a peripheral cutting edge opposite the connection side. In an implementation, the cutting shoe extends and defines a through-opening between the peripheral cutting edge and the connection side such that material can move from the cutting edge, through the cutting shoe into the hollow space of the elongated coring section. In an implementation, the cutting shoe defines one or more serrations along the peripheral cutting edge.

A serration in the present disclosure is understood as a protrusion along the peripheral cutting edge. The average height of the peripheral cutting edge can be defined as the average distance between the cutting edge and the connection side of the cutting shoe. It is an average defined between the protruding serrations and closer indentations between the serrations. This holds similarly if there is solely a single serration, defined between a single indentation which delimits the serration on either side. The serrations are protrusions extending away from this average distance between the peripheral cutting edge and the connection side of the cutting shoe. As such, the serrations are forwardly extending protrusions, which extend away from the average peripheral cutting edge distance.

The present disclosure addresses the problems of the cited art by providing one or more serrations along the peripheral cutting edge, which reduces soil friction and increases the depth at which the coring sampler can retrieve samples. Contrary to conventional cutting shoes, the cutting shoe provided in the present disclosure attains improved penetration characteristics on a given soil type. Conventional cutting shoes have a flat plane around the periphery of the opening through which soil must enter the coring sampler. The inventors found that the depth at which a coring sampler can retrieve samples is dependent to a large part on the force exerted to the cutting edge by the soil, which is referred to as frontal plane friction. The inventors have unexpectedly found that flat plane cutting edges experience higher frontal plane frictional forces which leads them to have lower penetration depths. The one or more serrations along the peripheral cutting edge have shown improved penetration depths. The one or more serrations allow for concentrated forces to push through challenging sections, such that a layer of harder material in the soil can be more readily penetrated. In addition to improved depth, another advantage is that the coring sampler of the present disclosure allows for the retrieval of denser materials such as sand and gravel beds. While a reduction in frontal plane friction can increase sampling depth in similar soil types, it could also retrieve samples from more challenging soil types at equal depths. Soil types that originally would not be possible to retrieve samples from using a flat plane cutting shoe now are accessible.

In an implementation, the cutting shoe comprises a substantially circular cross-section. Having a substantially circular cross-section of the cutting shoe reduces overall friction, improves manufacturing efficiency, and helps increase sample integrity as there is less variation in shear friction along the side walls of the cutting shoe.

In an implementation, the connection side of the cutting shoe has an outer connection diameter which is larger than an outer cutting diameter of the peripheral cutting edge, such that an outer surface of the engagement side is tapered towards the peripheral cutting edge. Having a tapered section moving from the connection side to the engagement side of the cutting shoe allows the connection side to be sufficiently wide for it to engage with the elongated coring section, while maintaining an equal inner cross-sectional shape and diameter. Tapering towards the peripheral cutting edge along the engagement side ensures that the total frontal surface defined by the peripheral cutting edge is kept to a minimum. The tapered section is formed such that the engagement side of the cutting shoe defines an angle with a centreline of the coring sampler.

In an implementation, an inner surface of the engagement side of the cutting shoe has a substantially circular cross-section and has an inner diameter which is substantially equal to an inner diameter of the hollow space of the elongated coring section.

Having equal diameters of the hollow section of the elongated coring section and the inner surface of the engagement side of the cutting shoe reduces total friction of a soil sample moving through the cutting shoe into the hollow section of the elongated coring section. In an advantageous implementation, the cross-sectional shape of the elongated coring section defining the hollow space and the cross-sectional shape of the engagement side of the cutting shoe are substantially equal. In such an implementation, the transition between the inner surfaces of the engagement side of the cutting and the elongated coring section is smooth such that friction of soil moving through the sampler is reduced.

In an implementation, the one or more serrations are formed by one or more recesses along the engagement side of the cutting shoe towards the peripheral cutting edge. Be removing material, advantageously by milling, or machining, from the cutting shoe, one or more recesses can be formed, which form the one or more serrations.

In an implementation, the one or more recesses define an angle with a surface of the engagement side of the cutting shoe. By providing the recesses at an angle with the outer surface of the engagement side, the recess starts at or adjacent to the connection side of the cutting shoe having a low width and expands as it moves towards the peripheral cutting edge. In an implementation where the engagement section of the cutting shoe is tapered, the angle defined by the one or more recesses in relation to the engagement section leads to an even further increased angle between the one or more recesses in relation to a centreline defined by the coring sampler.

In an implementation, the one or more recesses have an increasing width, moving from the connection side to the peripheral cutting edge. By increasing the width of the recesses moving from the connection side to the peripheral cutting edge, tooth-like serrations are formed between the recesses along the peripheral cutting edge. The material which is not removed will then attain a pointed form. In an advantageous implementation, the one or more recesses define curved sides in the engagement side of the cutting shoe.

In an implementation, the recesses are provided on an outer surface of the engagement side of the cutting shoe. In an alternative or additional implementation, the recesses are provided on an inner surface of the engagement side of the cutting shoe.

The serrations can be provided on an outer surface or on an inner surface of the engagement side of the cutting shoe, towards the peripheral cutting edge. In an implementation, serrations are provided on the inner surface and the outer surface. The serrations on the inner surface and the outer surface may be spaced such that a serration on the outer surface is radially positioned between two serrations on the inner surface. In such an implementation, the provision of the serrations on the inner and outer surface of the engagement side of the cutting shoe allows opposing serrations while reducing the total amount of material needed. In such an implementation, the frontal surface area of the cutting shoe is reduced and the increase of thickness towards the connection side is more gradual.

In an implementation, the length of the one or more recesses, is at least two times larger than the width of the one or more recesses. The width is defined as the largest dimension in a radial direction, around the periphery of the cutting shoe. In an implementation, the largest dimension is provided along the periphery of the cutting edge. In other implementations, the shape of the one or more recesses are provided such that the widest point is at another position along the surface of the engagement side of the cutting shoe. The length of the one or more recesses is defined as the major dimension along the engagement side of the cutting shoe orthogonal to the radial direction defining the width. The length direction of the one or more recesses is in substantially the same direction as a centreline of the coring sampler.

Having a length-to-width ratio of at least 1:2 ensures that the cutting shoe is provided with long serrations, which leads to a reduced angle of the recess in relation to the surface of the cutting shoe. As a result, the friction of the recesses with the surrounding soil is reduced. The provision of an angled recess also leads to a rounded section of the peripheral cutting edge between the serrations, which is defined by the recess. Having a low angle in relation to the outer surface of the cutting shoe increases cutting potential.

In an implementation, the connection side of the cutting shoe and the distal end of the elongated coring section comprise a threaded section. The threaded section allows the cutting shoe to be easily removeable from the elongated coring section and replaced with another cutting shoe. Through the threaded sections, this exchange can be done without any other mechanical changes, making it modular and applicable to multiple types of coring devices.

In an implementation, the surface of the cutting shoe comprises a friction-reducing coating. A friction-reducing coating may be provided on an outer surface of the cutting shoe. In an implementation, the friction-reducing coating is provided on an outer surface of the engagement side of the cutting shoe. In another or additional implementation, the friction-reducing coating is provided on an inner surface of the engagement side of the cutting shoe. In an implementation, the friction-reducing coating is provided on an outer and/or inner surface of the connection side of the cutting shoe. In an implementation, the entire surface area of the cutting shoe is provided with a friction-reducing coating.

In an implementation, the cutting shoe comprises steel. In an implementation, the cutting shoe comprises alloyed steel comprising at least chromium and molybdenum. In an implementation, the cutting shoe comprises 4140 alloy steel.

Steel alloyed with chromium and molybdenum and 4140 alloy steel are very tough, with particularly high torsional and fatigue strength. This makes it advantageous for rotating components that experience significant stress, such as axles and shafts.

In an implementation, the cutting shoe comprises a kiln-fired steel. In an alternative or additional implementation, the cutting shoe comprises nitrogen processed steel.

In an implementation, the cutting shoe defines at least four serrations. In a preferred implementation, the cutting shoe defines at least six serrations, advantageously at least eight serrations, more advantageously at least ten serrations, still more advantageously at least twelve serrations.

In an aspect according to the present disclosure, there is provided a method of retrieving a soil sample. In an implementation, the method comprises providing a coring sampler according to any of the implementations disclosed herein. In an implementation, the method comprises the step of positioning the coring sampler above a target region, such that the cutting shoe faces the target region. In an implementation, the method comprises driving the coring sampler into the target region such that the cutting shoe engages with the target region until a target depth is reached such that a target soil sample is driven into the hollow space of the coring sampler. In an implementation, the method comprises the step of retrieving the coring sampler from the target soil. In an implementation, the method comprises the step of retrieving the target soil sample from the coring sampler.

In an aspect according to the present disclosure, there is provided a cutting shoe for use in a coring sampler according to any of the example implementations discloses herein. In an implementation, the cutting shoe comprises a connection side and an engagement side, the connection side being arranged to be attached a distal end of an elongated coring section. In an implementation, the engagement side of the cutting shoe comprises a peripheral cutting edge opposite the connection side, such that the cutting shoe extends between and defines a through-opening between the peripheral cutting edge and the connection side such that material can move from the cutting edge, through the cutting shoe into a hollow space of the elongated coring section. The cutting shoe further defines one or more serrations along the peripheral cutting edge.

### EXPERIMENTAL RESULTS

Tests have been executed to verify the improvement pursuant the coring sampler of the present disclosure. Field tests have been executed using a cutting shoe having four serrations and using a cutting shoe having eight serrations. A base line test was done simultaneously using a standard flat plane cutting shoe without serrations. The tests were conducted at two different sites. In both test sites, the cutting shoe having four serrations showed improved penetration depth over the base line tests of the cutting shoe having a flat plane cutting edge and the cutting shoe having eight serrations showed still further improvement over the cutting shoe having four serrations. The results are shown in the below table.

| | | Penetration | Percentage difference |
|---|---|---|---|
| Location | Cutting shoe type | depth [m] | to base line [%] |
| Site 1 | Flat plane | 2.7 | N/A |
| Site 1 | Four serrations | 2.9 | 7 |
| Site 1 | Eight serrations | 4.6 | 70 |
| Site 2 | Flat plane | 1.8 | N/A |
| Site 2 | Four serrations | 2.4 | 33 |
| Site 2 | Eight serrations | 2.9 | 61 |

As shown in the above test results the cutting shoes having serrations provided on the peripheral cutting edge outperform the traditional flat plane cutting shoes. The increased penetration depth is the result of a lower friction provide by the soil to the cutting shoe due to the serrations. As a result of these improved characteristics, increased depths can be reached by the coring sampler leading to more efficient and less costly sampling. This allows operators to collect samples more effectively from a target soil, thus improving accuracy of the information gained of e.g., an offshore site. This improves decision making during e.g., subsequent construction activities.

### BRIEF DESCRIPTION OF THE DRAWINGS

In order to describe the manner in which the above-recited and other advantages and features of the disclosure can be obtained, a more particular description of the principles briefly described above will be rendered by reference to specific implementations thereof which are illustrated in the appended drawings. Understanding that these drawings depict only exemplary implementations of the disclosure and are therefore not to be considered to be limiting of its scope, the principles herein are described and explained with additional specificity and detail through the use of the accompanying drawings in which:

FIG. 1 is a three-dimensional view of one implementation of the invention showing the cutting shoe;

FIG. 2 is a; cross-sectional view of one implementation of the invention showing the cutting shoe; and

FIG. 3 is a side view of a coring sampler taking a sample from a seabed.

### DESCRIPTION OF ILLUSTRATIVE IMPLEMENTATIONS

The following is a description of certain implementations of the present disclosure, given by way of example only and with reference to the drawings.

Various implementations of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. A reference to an implementation in the present disclosure can be a reference to the same implementation or any other implementation. Such references thus relate to at least one of the implementations herein.

Reference to “one implementation” or “an implementation” means that a particular feature, structure, or characteristic described in connection with the implementation is included in at least one implementation of the disclosure. The appearances of the phrase “in one implementation” in various places in the specification are not necessarily all referring to the same implementation, nor are separate or alternative implementations mutually exclusive of other implementations. Moreover, various features are described which may be exhibited by some implementations and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various implementations given in this specification.

Without intent to limit the scope of the disclosure, examples of instruments, apparatus, methods and their related results according to the implementations of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

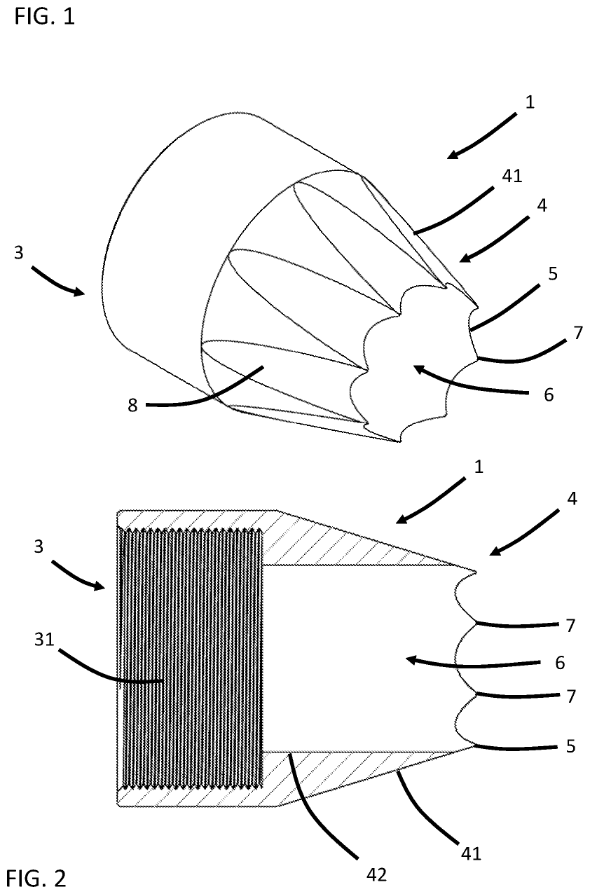

Referring to FIGS. 1 and 2, a cutting shoe 1 is shown, comprising a connection side 3 and an engagement side 4. The connection side 3 is arranged to be attached to a distal end of an elongated coring section, which is not shown in FIGS. 1 and 2.

The engagement side 4 of the cutting shoe 1 comprises a peripheral cutting edge 5 opposite the connection side 3, such that the cutting shoe 1 extends and defines a through-opening 6 between the peripheral cutting edge 5 and the connection side 3 such that material can move from the cutting edge 5, through the cutting shoe 1 into the hollow space of the elongated coring section, not shown in FIGS. 1 and 2.

The cutting shoe 1 of the shown implementation defines one eight serrations 7 along the peripheral cutting edge 5. As shown in FIG. 1, the cutting shoe 1 comprises a substantially circular cross-section. Additionally, the connection side 3 has an outer connection diameter which is larger than an outer cutting diameter of the peripheral cutting edge 5, such that an outer surface 41 of the engagement side 4 is tapered towards the peripheral cutting edge 5.

In the shown implementation, the inner surface 42 of the engagement side of the cutting shoe 1 has a substantially circular cross-section and has an inner diameter which is substantially equal to an inner diameter of the hollow space of the elongated coring section, which is not shown in FIGS. 1 and 2.

In the shown implementation, the eight serrations 7 are formed by eight corresponding recesses 8, which are milled into the surface of the engagement end 4 of the cutting shoe 1. As shown, the serrations 7 are provided between the recesses 8.

The shown recesses 8 are formed as linear cuts along the outer surface 41 of the engagement side 4 of the cutting shoe 1. That is, their surface area defines a rounded shape, extending linearly along the outer surface 41 of the engagement side 4. It appears as a polygonal shape since the linear rounded cut is made at an angle with the outer surface 41 of the engagement side 4 of the cutting shoe 1. The recesses 8 can alternatively be made in parallel with the outer surface 41 of the engagement side 4. The recesses 8 may extend into the connection side 3 of the cutting shoe 1. The recesses 8 may comprise any appropriate shape, such as a widening shape, such that the widest section of the recess 8 is not at the peripheral cutting edge 5. Alternatively, the recess 8 may comprise a flat plane.

In the shown embodiment, the recesses 8 meet at the peripheral cutting edge 5, such that two recesses 8 define a pointed serration 7. In an alternative implementation, the recesses 8 do not meet at the peripheral cutting edge 5 such that a flat cutting edge is defined in between the serrations 7. The serrations 7 may, in an alternative implementation also be rounded, or define another appropriate shape.

As shown in FIG. 2, the connection side 3 of the cutting shoe 1 comprises a threaded section 31. The threaded section 31 is arranged to connect to a distal end of an elongated coring section of the coring sampler 10.

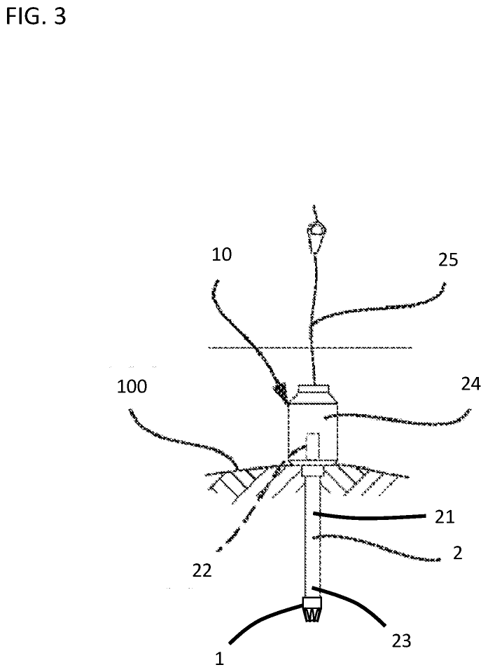

Referring now to FIG. 3, a coring sampler 10 for retrieving coring samples is shown. The coring sampler 10 in the shown example comprises an elongated coring section 2, defining at least a hollow space 21 extending between a proximal end 22 and a distal end 23. The coring sampler 10 is driven into the seabed 100.

In the shown implementation, the coring sampler 10 is provided as a free fall gravity coring sampler 10, arranged for being at least partly driven by its weight into layers of the seabed 100 and to collect samples from there, when released from a lift unit, not shown in FIG. 3. The shown implementation of the coring sampler 10 comprises a corer weight 24, which is connected to the proximal end 22 of the elongated coring section 2. As the coring sampler 10 reaches a required depth or height above the seabed 100, the coring sampler 10 is released such that it falls towards the seabed 100 and drives into the soil to retrieve a soil sample. The release mechanism required may be provided in any appropriate manner. In the shown implementation, the coring sampler 10 is connected to a tether 25, which is arranged to retrieve the coring sampler 10 once it has retrieved a sample.

The invention has been described by reference to certain implementations discussed above. It will be recognized that these implementations are susceptible to various modifications and alternative forms well known to those of skill in the art.

Further modifications in addition to those described above may be made to the structures and techniques described herein without departing from the spirit and scope of the invention. Accordingly, although specific implementations have been described, these are examples only and are not limiting upon the scope of the invention.

1. A coring sampler for retrieving coring samples, the coring sampler comprising:
an elongated coring section, defining at least a hollow space extending between a proximal end and a distal end; and
a cutting shoe comprising a connection side and an engagement side, the connection side being attached to the distal end of the elongated coring section,
wherein the engagement side of the cutting shoe comprises a peripheral cutting edge opposite the connection side, wherein the cutting shoe extends and defines a through-opening between the peripheral cutting edge and the connection side such that material can move from the cutting edge, through the cutting shoe into the hollow space of the elongated coring section, and
wherein the cutting shoe defines one or more serrations along the peripheral cutting edge.

2. The coring sampler according to claim 1, wherein the cutting shoe comprises a substantially circular cross-section.

3. The coring sampler according to claim 1, wherein the connection side of the cutting shoe has an outer connection diameter which is larger than an outer cutting diameter of the peripheral cutting edge, such that an outer surface of the engagement side is tapered towards the peripheral cutting edge.

4. The coring sampler according to claim 1, wherein an inner surface of the engagement side of the cutting shoe has a substantially circular cross-section and has an inner diameter which is substantially equal to an inner diameter of the hollow space of the elongated coring section.

5. The coring sampler according to claim 1, wherein the one or more serrations are formed by one or more recesses along the engagement side of the cutting shoe towards the peripheral cutting edge.

6. The coring sampler of claim 0, wherein the one or more recesses define an angle with a surface of the engagement side of the cutting shoe.

7. The coring sampler according to claim 0, wherein the one or more recesses have an increasing width, moving from the connection side to the peripheral cutting edge.

8. The coring sampler according to claim 0, wherein the open or more recesses are provided on an outer surface of the engagement side of the cutting shoe.

9. The coring sampler according to claim 5, wherein the one or more recesses are provided on an inner surface of the engagement side of the cutting shoe.

10. The coring sampler according to claim 5, wherein a length of the one or more recesses, is at least two times larger than a width of the one or more recesses.

11. The coring sampler according to claim 1, wherein the connection side of the cutting shoe and the distal end of the elongated coring section comprise a threaded section.

12. The coring sampler according to claim 1, wherein a surface of the cutting shoe comprises a friction-reducing coating.

13. The coring sampler according to claim 1, wherein the cutting shoe comprises steel.

14. The coring sampler according to claim 1, wherein the cutting shoe comprises alloyed steel comprising at least chromium and molybdenum.

15. The coring sampler according to claim 1, wherein the cutting shoe comprises 4140 alloy steel.

16. The coring sampler according to claim 1, wherein the cutting shoe comprises a kiln-fired steel.

17. The coring sampler according to claim 1, wherein the cutting shoe comprises nitrogen processed steel.

18. The coring sampler according to claim 1, wherein the cutting shoe defines at least four serrations.

19. A method of retrieving a soil sample, the method comprising:
providing a coring sampler;
positioning the coring sampler above a target region, wherein a cutting shoe faces the target region;
driving the coring sampler into the target region, wherein the cutting shoe engages with the target region until a target depth is reached such that a target soil sample is driven into a hollow space of the coring sampler;
retrieving the coring sampler from the target soil sample; and
retrieving the target soil sample from the coring sampler.

20. A cutting shoe for use in a coring sampler, comprising:
a connection side; and
an engagement side, the connection side being arranged to be attached a distal end of an elongated coring section,
wherein the engagement side of the cutting shoe comprises a peripheral cutting edge opposite the connection side, such that the cutting shoe extends between and defines a through-opening between the peripheral cutting edge and the connection side such that material can move from the cutting edge, through the cutting shoe into a hollow space of the elongated coring section, and
wherein the cutting shoe defines one or more serrations along the peripheral cutting edge.
